(19) United States
(12) Patent Application Publication
(10) Pub. No.: US 2019/0177086 A1
(43) Pub. Date: Jun. 13, 2019

(54) A PICKING SYSTEM HAVING A TRANSPORT ROBOT FOR MOVING UNDERNEATH INDIVIDUALSHELVES AND TRANSPORTING VEHICLE

(71) Applicant: KNAPP AG, Hart bei Graz (AT)

(72) Inventors: Franz MATHI, Gleisdorf (AT); Anton TSCHURWALD, Stattegg (AT); Gregor LEBERNEGG, Graz (AT); Wolfrum HOFBAUER, Gratkorn (AT)

(21) Appl. No.: 16/310,060

(22) PCT Filed: Jun. 13, 2017
(86) PCT No.: PCT/AT2017/060151

§ 371 Date: Dec. 14, 2018

(30) Foreign Application Priority Data
Jun. 14, 2016 (AT) GM 50103/2016

(51) Int. Cl. B65G 1/04; B65G 1/07; B65G 1/10; B65G 1/137

(52) U.S. Cl. CPC B65G 1/0457; B65G 1/07; B65G 2209/10; B65G 1/1378; B65G 2209/08; B65G 1/10

(57) ABSTRACT

An order-picking system for order-picking articles stored in a storage rack into conveying pockets includes a storage rack areas arranged in rack rows and/or rack levels for storing the articles, an overhead conveyor system for transporting conveying pockets, and an order-picking area in accordance with the ware-to-person principle, where a number of articles specified by a control computer can be order-picked into conveying pockets at the order-picking area. The storage rack is modular and in the form of independent individual racks. A transport robot is autonomous or controlled by the control computer and constructed to pass beneath an individual rack and/or a transport trolley and transport the individual rack and/or the transport trolley to the order-picking area an article stored in the individual rack and/or an article order-picked from the storage rack into the transport trolley in advance is to be order-picked into a conveyor pocket at the order-picking area.

The invention relates to a picking system for picking articles stored in a racking into conveyor pockets having a plurality of racking spaces of the racking that are arranged in racking rows and/or racking levels for storing the articles and having a suspended conveyor technique for transporting conveyor pockets and having a picking station according to the good-to-person principle, at which a number of articles predetermined by a controlling computer may be picked into conveyor pockets.

The invention further relates to a picking method for picking articles stored in a racking into conveyor pockets using a controlling computer for handling picking orders, which provides the picking at the at least one picking station according to the following method steps: Transport of an article required for a picking order from the racking to the picking station; Picking the number of articles required for the picking order into the conveyor pockets assigned to the at least one picking order at the picking station.

The document DE 10 2011 116 081 B3 discloses such a picking system and picking method, wherein a storage container conveyor technique transports storage containers into the working area of a picking person, whereupon the number of articles specified by a control device are retrieved by the picking person from the storage container and are put into conveyor pockets of a picking order. A suspended conveyor technique transports the conveyor pockets off, into which articles have been picked by the picking person. In this way, there may be performed a batch picking, wherein articles of several orders are put into one conveyor pocket. In a subsequent puffer and sorting area, the conveyor pockets are temporarily stored and/or put into the correct sequence in order to pack the articles at a subsequent packing station into respectively one order container per order. Batch picking has the advantage that the storage container conveyor technique is being relieved, as the storage container of a particular type of article need not be retrieved every time and then be put back following the picking, but rather several articles of this type may be retrieved for several orders and may be picked as a “batch” into a conveyor pocket.

With this well-known picking system it has proven to be a disadvantage that the storage container conveyor technique, in spite of batch picking, represents a bottleneck for the number of picking stations, to which storage containers with articles to be picked have to be transported in parallel. In particular for so-called fast turning articles, the storage containers have to be retrieved and restored very frequently, which may constitute a delay for other picking stations, which require the same fast turning article for picking.

A site-installed conveyor technique further has several disadvantages. It is not only expensive in the production thereof but may also be scaled according to the current demand rather rigidly and badly. It has to be configured to handle the maximum performance required, but over extended periods of time it will be used only to a proportion of its capacity. If the layout of the picking system is to be altered, e.g. for the integration of further picking stations, there will usually be necessary large and expensive reconfiguration works.

The invention is thus based on the task to provide a picking system, wherein the preceding disadvantages are being prevented. According to the invention, this task is solved in a picking system by the racking being configured to be modular in the form of independent individual shelves and by being provided at least one transport robot controlled by the controlling computer or being autonomous, which is configured to move underneath an individual shelf and to transport the individual shelf to the picking station, if at least one article stored in the individual shelf is to be picked into a conveyor pocket.

According to the invention this task is solved in a picking system by the provision of the following further method steps:

that the transport of the article required for the picking order is conducted such that an individual shelf of the racking, in which the article is being stored, is transported using a transport robot from the racking to the picking station and that the number of articles required for the picking order is picked into conveyor pockets.

In this way there is given the advantage that a classical storage container conveyor technique for retrieving storage containers and for transporting the storage containers from the racking to the picking station may be omitted. Optionally, also the provision of storage containers may be omitted at all, as the entire individual shelf will be transported. As the racking is formed to be modular by individual shelves that are being arranged next to each other, any individual shelf containing an article to be picked may be transported out of the row of individual shelves at any time. For this purpose, there is provided a transport robot that is controlled by a controlling computer of the picking system or that moves autonomously, which is configured to be small enough to move underneath the individual shelf. Furthermore, it is particularly advantageous that there may be transported and simultaneously be provided on an individual shelf various articles according to the specific customers. Alterations to the layout as well as extensions thereof will be handled substantially more easily as only other points are determined in the layout or a transport robot is added. The transport performance need not be determined in advance, as a temporary addition of transport robots will lead to an increase of the transport performance.

It is to be noted that such a transport robot for transporting individual shelves may be purchased from the company Kiva or Swisslog. There have been known picking systems, wherein these transport robots transport the individual shelves from the racking to the picking station according to the good-to-person principle, whereby articles are picked exclusively from the individual shelves of the racking into other shelves. Although these transport robots have been commercially available for a couple of years, none of those skilled in these technologies has so far created the inventive combination of the transport of individual shelves to a picking station according to the goods-to-person principle, at which batch picking into conveyor pockets will be accomplished. Only by way of the inventive combination of measures that have been known per se, there has been enabled an effective picking system and picking method with particularly few transport runs between the racking and the picking station.

It is advantageous to determine individual shelf transport paths, along which the transport robots may transport the individual shelves without bumping into objects or colliding with other transport robots. These individual shelf transport paths may be conducted also in particular sections using the suspended conveyor technique in order to create individual shelf transport paths that are as short as possible. It is particular advantageous to provide individual shelf transport paths between picking stations in order to transport individual shelves with articles that are required for picking first at one picking station and later on at the other picking station not via the racking but rather in a direct way.

It is particular advantageous to equip the transport robots with a laser scanner, which scans the surroundings of the transport robots at an opening angle of 270 degrees and a repeat frequency of, for example, 12 Hz in order to recognize objects that might be present on the transport path and in order to support the determination of the transport direction. In this way, there is obtained an especially reliable and inexpensive control unit for the detection of objects and the prevention of collisions with these objects.

It is further advantageous to have the transport robot scan and store in a learning mode the layout of the racking, this is the positions and dimensions of objects such as pillars of the warehouse, walls or doors. This positional information may then be used for the determination of the transport direction in order to run along the individual shelf transport paths. In this learning mode, the transport robot may be driven manually or also by a motor to be transported along the individual shelf transport paths. The image of objects next to the individual shelf transport paths resulting thereof may then be touched up manually using the computer of the control unit in order to, for example, delete feet of the operator within the path during the run in the learning mode. Subsequently, these positional information may be transferred to all transport robots of the picking system. According to a further embodiment variant, the learning mode may be omitted and the layout of the picking system with its individual transport paths may be input directly into the transport robots and stored therein.

Further advantageous embodiments of the inventive picking system and picking method are explained in greater detail in the following by way of the figures.

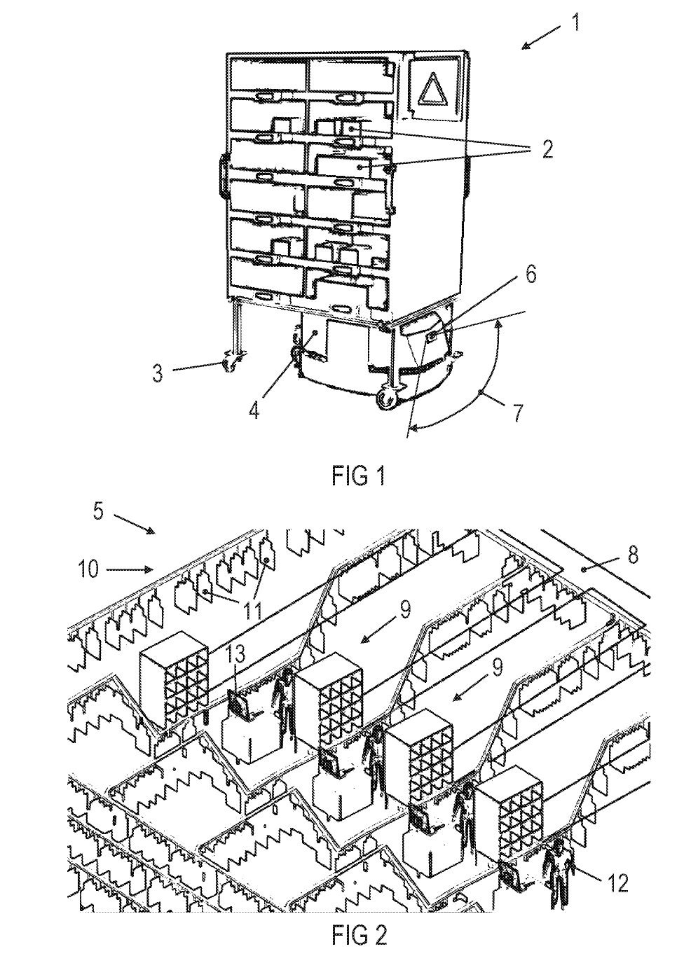

FIG. 1 shows an individual shelf, underneath which there is positioned a transport robot.

FIG. 2 shows several picking stations having individual shelves that have been transported by transport robots from a racking and having suspended conveyor technique for transporting off conveyor pockets with picked articles in an oblique view.

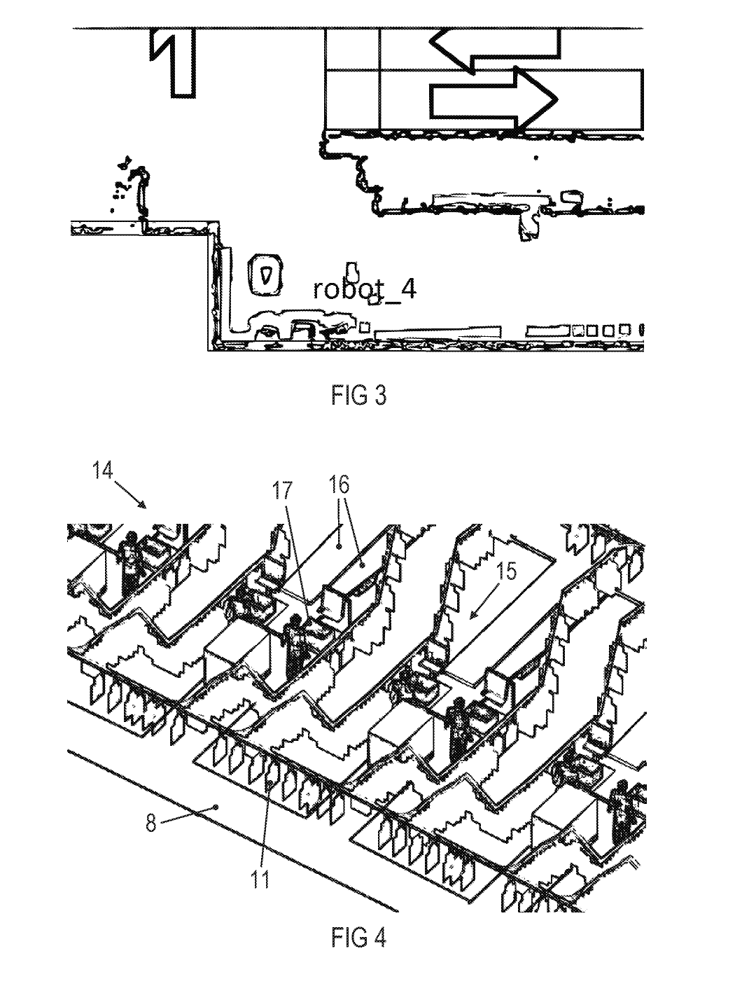

FIG. 3 shows the positional information stored by a transport robot in a learning mode.

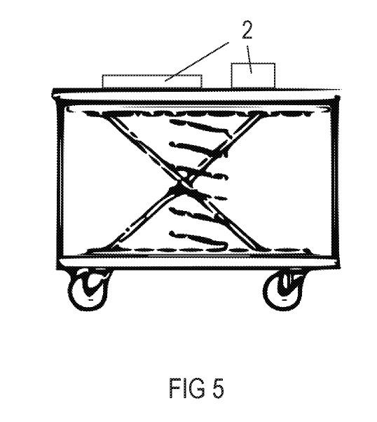

FIG. 4 shows several picking stations having individual shelves that have been transported by transport robots from a racking and having suspended conveyor technique for transporting off conveyor pockets with picked articles and having a belt conveyor for transporting off order container boxes with picked articles in an oblique view.

FIG. 5 shows a transporting vehicle in the form of a spring-bottom vehicle.

FIG. 1 shows an individual shelf 1 of a racking, which is composed of a plurality of such individual shelves 1 that are arranged one after the other and which is provided for storing articles 2. The individual shelf 1 has wheels 3 at the feet of the individual shelf 1 in order to roll the individual shelf 1, without any particular energy effort, on the floor. Underneath the individual shelf 1 there is visible a transport robot 4, which is driven electrically and has a control unit, which is controlled by a controlling computer of the picking system 5 depicted in FIG. 2. Such transport robots 4 are, for example, sold by the company Kiva or Swisslog, wherein the transport robot 4 has particular inventive features.

The transport robot 4 does not lift the individual shelf 1 but rather rolls it, using its wheels, on the floor, whereby the transport robot 4 has a technically simple set-up and consumes less energy than if it had to lift every individual shelf 1 to be transported off the ground. The transport robot 4 further has a laser scanner 6, which scans objects that are positioned within an opening angle 7, in order to prevent potential collisions with these objects. The transport robot 4 may have further sensors in order to improve navigation within the picking system 5. For this purpose, it may have a gyroscope for the determination of the position of the transport robot 4. The transport robot 4 may further have a reflector detector for the detection of reflectors at objects such as rackings or walls. The transport robot 4 may further have an RFID reader for the detection of RFID tags on objects or in the ground. These RFID tags may indicate individual shelf transport paths 8, which are provided for the transport of individual shelves 1 by the transport robot 4. The transport robot 4 may further have a barcode scanner for the detection of barcodes at objects or individual shelf transport paths 8. The transport robot 4 may further have an indoor GPS for the determination of the position, or it may use a WLAN network in the racking for WLAN triangulation. The transport robot 4 may further use odometrics for the detection of positional changes by way of wheel revolutions of the transport robot 4. All these sensors enable the transport robot 4 of the picking system 5 to transport individual shelves 1 between the racking and picking stations 9 without colliding with objects or persons.

The transport robot 4 further has an emergency stop safety system, which will always stop the transport robot 4 if there is unexpectedly detected an object or a person within a safety area around the transport robot 4. The safety area may, for example, be monitored by the laser scanner 6 and may comprise an area of 50 centimetres in front of the transport robot 4 in the direction of transport. The safety area, however, may also have the size of only 30 centimetres or one metre. In this way there will be ensured that no collisions will occur.

The transport robot 4 now is further configured to learn the position and the dimension of objects along the individual shelf transport paths 8 by measuring using the laser scanner 6 and storing the measurement results. For this purpose, the transport robot 4 is manually moved by an operator along the individual transport paths 9, wherein the laser scanner 6 determines positional information, as depicted as examples in FIG. 3. Every point in the top view onto a part of the picking system 5 shows the positional information determined by the laser scanner 6. In this way, there are visible walls and other objects. If objects have been measured by the laser scanner 6 in the learning modus, which are not permanently existent in the picking system 5, such as, e.g. the legs of an operator, then this positional information may be deleted at a computer of the controlling computer of the picking system 5. The corrected positional information, which shows an image of the layout of the picking system 5 and thus in particular the surroundings of the individual transport paths 8, will subsequently be transmitted by the controlling computer of the picking system 5 to the control units provided in the transport robots 4. In this way, there is given the advantage that every transport robot 4 has at its disposal exact positional information for the transport of individual shelves along individual shelf transport paths 8 between the racking and picking station 9.

FIG. 2 now shows several picking stations 9 of the picking system 5 having individual shelves 1 in an oblique view. The individual shelves 1 have been transported by transport robots 4 from a racking via individual transport paths 8 to the picking stations 9. At the picking stations 9 there is further provided a suspended conveyor technique 10 for transporting off conveyor pockets 11. At every picking station 9 is positioned a picking person 12, which receives indication about which number of which article 2 in the individual shelf 1 is to be retrieved from the individual shelf 1 and to be picked into one or several conveyor pockets 11. Thus the controlling computer is also configured to perform batch picking in order to pick articles 2 of several orders into only one conveyor pocket 11 at first. The articles 2 are then put into order containers and dispatched at a downstream sorting and packing station, respectively assigned to the individual orders.

By providing the transport robots 4 in order to retrieve entire individual shelves 1 from the racking, in combination with batch picking into container and in particular into conveyor pockets 11, there is obtained the advantage that particularly few transports have to be realized between the racking and the picking station 9. A classical storage container conveyor technique may be omitted altogether, thus saving costs and achieving high flexibility. This goes in particular back to the fact that at any point of time new or altered individual shelf transport paths 8 may be determined in a relatively simple way. By way of a particular configuration of the suspended conveyor technique 10 and the individual shelf transport paths 8 there is achieved that individual shelf transport paths 8 are situated in some sections underneath the suspended conveyor technique 10, which is why the space in the picking system 5 may be used in a particularly space-saving way. As visible by way of FIG. 2, also the picking stations 9 are connected to each other by way of individual shelf transport paths 8, whereby individual shelves 1 may also be transported directly from one picking station 9 to another picking station 9, if an article 2 of the individual shelf 1 is there required for picking. In this way, picking may be conducted in an especially efficient and time-saving way.

FIG. 4 shows a picking system 14 according to a further exemplary embodiment of the invention, wherein, in comparison to the picking system 5 according to FIG. 2, there are additionally provided at each picking station 5 conveyor belts 16 for transporting thereto and off order container boxes 17 with picked articles 2. In this way there is gained the advantage that at the picking stations 15 it is possible to pick into conveyor pockets 11 as well as into order container boxes 17, in parallel or successively. In this way there may be realized batch picking and order picking in parallel into conveyor pockets 11 and/or order container boxes 17.

There is to be noted that the transport robot might also transport individual shelves autonomously and not directly controlled by the controlling computer in the picking system. In this case, the control robot would simply transmit to the transport robot, e.g., a list of individual shelves and picking stations, to which the individual shelves are to be transported. The transport robot could then autonomously plan and conduct the transports required therefore.

According to a further embodiment example of the invention, the individual shelves do not have wheels at the legs, which is why the transport robots have a lifting technology in order to lift individual shelves slightly off the ground and only then transport these. According to this exemplary embodiment there is ensured that the individual shelves are always reliably positioned at their position.

According to a further exemplary embodiment of the invention not depicted in the figures, the picking system and the picking method are configured for pre-picking articles into one or several transporting vehicles. According to the exemplary embodiments explained above, the individual shelves containing the articles to be picked are transported to the picking station, which according to this exemplary embodiment need not be done as there are transported by the transporting vehicle only articles, which are actually to be picked at the picking station. Transporting vehicles have an area, into which articles may be put and, in this way, may be pre-picked or batch picked. Spring-bottom vehicles known per se to those skilled in the art are especially suitably to be used as transporting vehicles, wherein articles are put onto a bottom that is spring-pushed upwards, as visible in FIG. 5. The bottom will lower if several or heavy articles have been put into the spring bottom vehicle, whereby further articles may be advantageously put onto the articles already situated in the spring-bottom vehicle, without bending down. In this way the volume of the articles transported using the transporting vehicle may be substantially increased. The transporting vehicles themselves do not have a drive unit, but a transport robot may move underneath, which may then transport the transporting vehicle along the individual shelf transport paths.

The controlling computer is configured to transport an empty transporting vehicle or a transporting vehicle containing an already pre-picked article to those racking spaces in the racking, at which the articles to be picked are stored. Controlling computer is to be understood herein as the computer controlling the entire racking including the picking stations as well as the computer provided in the individual transport vehicles. Pre-picking these articles from the racking space into the transporting vehicle may be realized manually by a picking person or also by a robot arm in an automated way. The robot arm could be arranged on the transport robot, the transporting vehicle or at any other location of the racking. The transporting vehicle containing the pre-picked articles is transported using a transport robot, which is controlled by the controlling computer, to that picking station, at which the pre-picked articles situated in the transporting vehicle are to be picked into order containers and/or conveyor pockets. Articles for a picking order may be transported by one or several transporting vehicles to the picking station. One transporting vehicle may also pre-pick articles for two or more picking stations, which is why the transporting vehicle is transported to the other picking station after the articles retrieved by the picking person at a picking station have been removed. After having removed all pre-picked articles from the transporting vehicle and picking the articles at the picking station, the empty transporting vehicles may then be used for further pre-picking orders.

Using transporting vehicles has the advantage that not the entire individual shelf has to be transported to the picking station, which represents a substantial load and energy effort for the transport robot. There is further gained the advantage that, if one type of article is required for several picking orders at several picking stations more or less at the same time for picking, then this task may be performed by several transporting vehicles in parallel, and it is not necessary to wait at a picking station until the individual shelf with this article will no longer be needed at another picking station. In this way, the operational capacity of picking orders may be substantially increased.

1.-14. (canceled)

15. A picking system for picking articles stored in a racking into conveyor pockets, comprising:
a plurality of racking spaces of the racking that are arranged in racking rows and/or racking levels for storing articles and having
a suspended conveyor technique for transporting conveyor pockets and having a picking station according to the good-to-person principle, at which a number of articles predetermined by a controlling computer may be picked into conveyor pockets, wherein the racking is configured modular in the form of independent individual shelves, and that there is provided at least one transport robot controlled by the controlling computer or being autonomous, which is configured to move underneath an individual shelf and/or a transporting vehicle and to transport the individual shelf and/or the transporting vehicle to the picking station, if at least one article stored in the individual shelf and/or one article pre-picked from the racking into the transporting vehicle is to be picked at the picking station into a conveyor pocket, wherein there are provided at least two picking stations, and that there is provided an individual shelf transport path between the two picking stations in order to transport the individual shelf and/or the transporting vehicle using the transport robot from the one picking station to the second picking station.

16. A picking system according to claim 15, wherein the transporting vehicle is formed by a spring-bottom vehicle.

17. A picking system according to claim 15, wherein there are provided individual shelf transport paths, which enable a transport of any individual shelf and/or transporting vehicle of the racking using the transport robot from the racking to the at least one picking station.

18. A picking system according to claim 17, wherein the individual shelf transport paths are provided at least in some sections underneath the suspended conveyor technique.

19. A picking system according to claim 15, wherein there is provided an order container conveyor technique for transporting order containers to the at least one picking station and that the controlling computer is configured to predetermine the number of articles, which are to be picked into the order container and into the conveyor pockets.

20. A picking system according to claim 15, wherein the transport robot has a control unit having a laser scanner in order to detect objects and prevent collisions with these objects.

21. A picking system according to claim 20, wherein the control unit may learn in a learning modus the position and the dimension of objects along individual shelf transport paths by measuring using the laser scanner and by storing the measurement results.

22. A picking system according to claim 21, wherein the transport robot has one or several of the following sensors for improved navigation: gyroscope for the determination of position; reflector detector for the detection of reflectors at objects; RFID reader for the detection of RFID tags at objects or individual shelf transport paths; barcode scanner for the detection of barcodes at objects or individual shelf transport paths; indoor GPS; WLAN triangulation; odometry for the detection of the change of position by way of wheel revolutions.

23. A picking system according to claim 21, wherein the transport robot comprises an emergency stop safety system, which stops the transport robot if there is unexpectedly detected an object or a person in a safety area around the transport robot.

24. A picking method for picking articles using a controlling computer for handling picking orders, comprising the steps of:
transporting an article required for a picking order from a racking to a picking station;
picking the number of articles required for the picking order into the conveyor pockets assigned to the at least one picking order at the picking station, wherein the transport of the article required for the picking order is conducted such that an individual shelf of the racking, in which the article is being stored, and/or a transporting vehicle, into which the article from the racking has been picked, is transported using a transport robot form the racking to the picking station and that the number of articles required for the picking order is picked from the individual shelf and/or the transporting vehicle into conveyor pockets, wherein a transport of articles required for the picking order that are stored in the individual shelf and/or the transporting vehicle is conducted between at least two picking stations on an individual shelf transport path between the two picking stations.

25. A picking method according to claim 24, wherein the transport robot is moved manually or moves, respectively, along individual shelf transport paths in a learning modus, wherein a sensor, in particular a laser scanner, measures and stores the position and dimension of objects along the individual shelf transport paths in order to detect these during subsequent transport runs on the individual shelf transport path for direction control.

26. A picking method according to claim 24, wherein empty transporting vehicles are transported by a transport robot for pre-picking articles to be picked at the picking station to the racking, in which the article to be picked is being stored.

27. A picking method according to claim 26, wherein a transporting vehicle containing already at least one article to be picked is transported by the transport robot to the at least one further individual shelf in order to pre-pick there a further article to be picked into the transporting vehicle.
